(19) United States
(12) Patent Application Publication
(10) Pub. No.: US 2021/0037880 A1
(43) Pub. Date: Feb. 11, 2021

(54) Smoking Article, Smoking System And Method For Aerosol Generation

(71) Applicant: JT International S.A., Geneva (JP)

(72) Inventors: Andrew Robert John Rogan, Forres (GB); Takashi Hasegawa, Tokyo (JP); Eduardo Jose Garcia Garcia, Grand-Sacconex (CH); Shinichiro Uemura, Tokyo (JP)

(73) Assignee: JT International S.A., Geneva (CH)

(21) Appl. No.: 16/979,698

(22) PCT Filed: Apr. 25, 2019
(86) PCT No.: PCT/EP2019/060578

§ 371 Date: Sep. 10, 2020

(30) Foreign Application Priority Data
Apr. 27, 2018 (EP) 18169745.9

(51) Int. Cl. A24D 1/22; A24F 42/10; A24F 42/60; H05B 6/10

(52) U.S. Cl. CPC A24D 1/22; H05B 6/105; A24F 42/60; A24F 42/10

(57) ABSTRACT

A smoking article includes aerosol generating material and a combustible heat source for heating the aerosol generating material. The combustible heat source includes a combustible material and an inductively heatable susceptor for heating and thereby igniting the combustible material. A smoking system including a smoking article and an igniter is also described, along with a method for aerosol generation.

### TECHNICAL FIELD

The present disclosure relates generally to a smoking article, and in particular to a smoking article for generating an aerosol for inhalation by a user of the smoking article. Embodiments of the present disclosure also relate to a smoking system and to a method for aerosol generation using the smoking system.

### TECHNICAL BACKGROUND

Devices which heat, rather than burn, an aerosol generating material to produce an aerosol for inhalation have become popular in recent years. Such devices can use one of a number of different approaches to provide heat to the aerosol generating material.

One such approach is to provide a smoking article that utilises a combustible heat source and an aerosol generating material, for example tobacco, positioned adjacent to, and downstream of, the combustible heat source. When the combustible heat source is ignited, heat is transferred from the ignited combustible heat source to the aerosol generating material causing it to release volatile compounds. As the released volatile compounds are entrained in air flowing through the smoking article, they cool and condense to form an aerosol that can be inhaled by a user of the smoking article.

Embodiments of the present disclosure seek to provide an improved smoking article which has increased user appeal.

### SUMMARY OF THE DISCLOSURE

According to a first aspect of the present disclosure, there is provided a smoking article comprising:
aerosol generating material;
a combustible heat source for heating the aerosol generating material;
wherein the combustible heat source comprises a combustible material and an inductively heatable susceptor for heating and thereby igniting the combustible material.

Heat is transferred from the combustible heat source, and more particularly from the ignited combustible material, to the aerosol generating material to heat the aerosol generating material. The aerosol generating material is heated without burning to volatise at least one component of the aerosol generating material and thereby generate an aerosol for inhalation by a user of the smoking article.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The inductively heatable susceptor can be heated in the presence of a time varying electromagnetic field and provides a safe, effective and convenient way to ignite the combustible material without the need to use an external ignition source, such as a conventional lighter.

The inductively heatable susceptor may comprise one or more, but not limited, of aluminium, iron, nickel, stainless steel and alloys thereof, e.g. Nickel Chromium or Nickel Copper.

The combustible heat source and the aerosol generating material may be substantially axially aligned. The combustible heat source and the aerosol generating material may be in abutment with each other.

The combustible material may comprise any suitable combustible fuel material including, but not limited to, carbon, aluminium, magnesium, carbides, nitrides and mixtures thereof. The combustible material ideally has a high heat generating capacity and produces very low amounts of incomplete combustion by-products and provides for sufficient mechanical strength of the combustible heat source. In preferred embodiments, the combustible material is carbon-based and may comprise primarily carbon.

The inductively heatable susceptor may comprise a plurality of particles of susceptor material distributed within the combustible material. The use of a particulate susceptor material facilitates manufacture of the smoking article.

The particles of susceptor material may be distributed substantially evenly within the combustible material. Uniform heating, and hence ignition and combustion, of the combustible material is thereby assured.

The particles of susceptor material may have a concentration which varies within the combustible material in a longitudinal direction of the article. This allows the combustion process to be controlled and, hence, allows the heating of the aerosol generating material to be controlled to ensure that an aerosol with optimum characteristics is generated.

In one embodiment, the concentration of the particles of susceptor material may increase in the downstream direction and may be at its highest immediately adjacent to the aerosol generating material. Thus, combustible material at the downstream end of the combustible heat source may be ignited before the combustible material at the upstream end. With this arrangement, the aerosol generating material may be heated to a high temperature at an early point in time, shortly after ignition of the combustible material by the heated susceptor. Thus, an aerosol suitable for inhalation by a user may be generated rapidly, thereby ensuring that the smoking article is available for use by the user as quickly as possible.

In another embodiment, the concentration of the particles of susceptor material may decrease in the downstream direction and may be at its highest at the upstream end in a region furthest away from the aerosol generating material. Thus, the combustible material at the upstream end of the combustible heat source may be ignited before the combustible material at the downstream end. With this arrangement, the aerosol generating material may be heated to a high temperature at a later point in time and may be heated to a lower temperature following initial ignition of the combustible material by the heated susceptor. This ensures that a consistent amount of aerosol is generated throughout the duration of a complete smoking session, in particular because as the smoking session progresses, the constituents of the aerosol generating material become depleted and a greater heat input into the aerosol generating material is required to ensure that a consistent amount of aerosol is generated. If the heat input into the aerosol generating material was constant throughout the duration of the smoking session, it will be understood that decreased aerosol generation would be experienced during the latter part of the smoking session.

The inductively heatable susceptor may comprise a tubular member which may have a longitudinal axis which is substantially aligned with a longitudinal axis of the article. Effective heating of the combustible material, and hence, of the aerosol generating material, is assured with this arrangement.

The combustible material may be positioned in an interior of the tubular member and around an exterior of the tubular member. This ensures optimum heat transfer from the tubular member (i.e. susceptor) to the combustible material and, hence, optimum heating of the combustible material.

The tubular member and combustible heat source may each have an axial length.

In one embodiment, the axial length of the tubular member and the axial length of the combustible heat source may be substantially equal. In other words, axial ends of the tubular member and the combustible heat source may be substantially axially aligned, in the longitudinal direction of the article. A plurality of the combustible heat sources can be easily mass produced by cutting a continuous elongate rod at predetermined positions, the continuous elongate rod comprising a continuous tubular member and combustible material positioned in an interior of the continuous tubular member and around an exterior of the continuous tubular member.

In another embodiment, the axial length of the tubular member may be less than the axial length of the combustible heat source. In other words, axial ends of the tubular member and the combustible heat source may not be substantially axially aligned, in the longitudinal direction of the article. With this arrangement, the tubular member is fully encapsulated by the combustible material thereby maximising heat transfer from the tubular member (i.e. susceptor) to the combustible material.

The combustible material may be positioned exclusively around an exterior of the tubular member. With this arrangement, the tubular member may provide an airflow passage which is isolated by the wall of the tubular member from the combustible material positioned around its exterior. This may advantageously reduce the amount of combustion by-products, such as carbon dioxide and carbon monoxide, generated as a result of combustion of the combustible material that are entrained in the air which flows through the airflow passage and to a mouthpiece of the smoking article.

The smoking article may further comprise one or more inductively heatable components, for example metallic components. In preferred embodiments, no inductively heatable components other than the inductively heatable susceptor overlap the combustible material in a longitudinal direction of the article. With this arrangement, even if the one or more inductively heatable components are heated in the presence of a time varying electromagnetic field, heating and ignition of the combustible material is provided exclusively due to heating of the inductively heatable susceptor of the combustible heat source.

The combustible material may comprise a plurality of pores. The pores allow ambient air to flow into the combustible material thereby promoting ignition and combustion of the combustible material but ideally do not allow air flowing through the combustible heat source to reach a user.

The smoking article may comprise a chamber downstream of the aerosol generating material. The chamber advantageously allows heated air and volatised components within the heated air to cool and condense to form an aerosol with optimum characteristics for inhalation by a user. The smoking article may comprise a cylindrical body which defines the chamber.

The smoking article may comprise a mouthpiece downstream of the aerosol generating material. The mouthpiece may be downstream of the chamber. The mouthpiece may comprise an air-permeable plug, for example comprising cellulose acetate fibres.

The aerosol generating material may be any type of solid or semi-solid material. Example types of aerosol generating solids include granules, pellets, powder, shreds, strands, particles, gel, strips, loose leaves, cut filler, porous material, foam material or sheets. The aerosol generating material may comprise plant derived material and in particular, the aerosol generating material may comprise tobacco.

The aerosol generating material may comprise an aerosol-former. Examples of aerosol-formers include polyhydric alcohols and mixtures thereof such as glycerine or propylene glycol. Typically, the aerosol generating material may comprise an aerosol-former content of between approximately 5% and approximately 50% on a dry weight basis. In some embodiments, the aerosol generating material may comprise an aerosol-former content of approximately 15% on a dry weight basis.

Upon heating, the aerosol generating material may release volatile compounds. The volatile compounds may include nicotine or flavour compounds such as tobacco flavouring.

According to a second aspect of the present disclosure, there is provided a smoking system comprising:
a smoking article as defined above; and
an igniter for igniting the combustible material, the igniter comprising an induction coil for inductively heating the susceptor.

The igniter provides a convenient way for a user to heat the inductively heatable susceptor and, therefore, ignite the combustible material. The heating of the combustible material is not user dependent and is, therefore, repeatable because it is carried out in a controlled manner by the inductively heatable susceptor rather than by a user with an external ignition source, such as a conventional lighter. This provides for improved aerosol generation and provides a safe, effective and convenient way to ignite the combustible material.

The induction coil may be helical and may define a cavity for receiving the smoking article, or at least a part of the smoking article. The induction coil may surround substantially all of the susceptor when the smoking article is positioned in the cavity. The inductively heatable susceptor is heated in an optimum manner, thereby ensuring optimum heating, and hence ignition, of the combustible material.

The position of the smoking article relative to the position of the induction coil may be determined by the cavity. This allows the positional relationship between the susceptor and the induction coil to be optimised thereby providing for optimum coupling of the electromagnetic field generated by the induction coil with the susceptor and, thus, optimum heating of the susceptor.

The igniter may comprise an air supply mechanism which may be configured to supply air to the combustible material. The air supply mechanism may comprise a fan and may comprise an airflow passage at an end of the cavity to direct air to the combustible material. The air supply mechanism may help to promote ignition and combustion of the combustible material.

According to a third aspect of the present disclosure, there is provided a method for aerosol generation, the method comprising:
providing a smoking system as defined above;
positioning the combustible heat source proximate the induction coil so that the inductively heatable susceptor couples with, and is heated by, an electromagnetic field generated by the induction coil; and
maintaining the position of the combustible heat source until the combustible material is ignited by the heated susceptor so that heat generated by the ignited combustible material heats the aerosol generating material to generate an aerosol.

After ignition of the combustible material by the heated susceptor, the method may comprise removing the combustible heat source from its position proximate the induction coil, for example to terminate heating of the inductively heatable susceptor by the electromagnetic field generated by the induction coil. Following removal of the combustible heat source, the ignited combustible material continues to combust and, thus, heat the aerosol generating material to generate the aerosol.

The method provides a simple and effective method for aerosol generation using the smoking system according to the present disclosure.

### BRIEF DESCRIPTION OF THE DRAWINGS

FIG. 1 is a diagrammatic longitudinal cross-sectional view of a first embodiment of a smoking article;

FIGS. 2 to 6 are diagrammatic cross-sectional views of examples of combustible heat sources for use with the first embodiment of the smoking article illustrated in FIG. 1;

FIG. 7 is a diagrammatic longitudinal cross-sectional view of a second embodiment of a smoking article;

FIGS. 8 to 11 are diagrammatic cross-sectional views of examples of combustible heat sources for use with the second embodiment of the smoking article illustrated in FIG. 7; and

FIGS. 12 to 15 illustrate diagrammatically a smoking system and a method for aerosol generation using the smoking system.

### DETAILED DESCRIPTION OF EMBODIMENTS

Embodiments of the present disclosure will now be described by way of example only and with reference to the accompanying drawings.

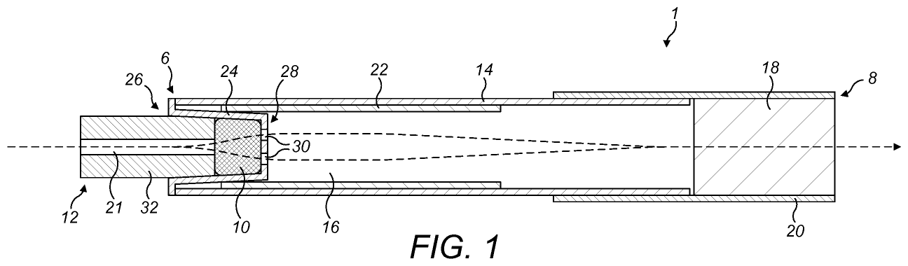

Referring initially to FIG. 1, there is shown a first embodiment of a smoking article 1 comprising an aerosol generating material 10 and a combustible heat source 12 which when combusted is arranged to heat the aerosol generating material 10. The article 1 is elongate and substantially cylindrical. Airflow through the article 1 is from left to right as shown diagrammatically by the arrow in FIG. 1, from an upstream end 6 of the article 1 to a downstream end 8. The aerosol generating material 10 is located downstream of the combustible heat source 12 and in abutment with it.

The smoking article 1 comprises an open-ended cylindrical body 14 which defines an elongate chamber 16 and is typically formed of cardboard or thick paper. The smoking article 1 comprises a mouthpiece 18 at the downstream end 8 which is in abutting coaxial alignment with the cylindrical body 14. The mouthpiece 18 comprises an air-permeable plug, for example comprising cellulose acetate fibres. Both the cylindrical body 14 and the mouthpiece 18 are overwrapped by an outer wrapper 20 typically comprising tipping paper. The smoking article 1 further comprises an open-ended cylindrical liner 22, for example comprising aluminium and/or paper, which extends along part of the interior of the cylindrical body 14 without overlapping the combustible heat source 12.

The aerosol generating material 10 comprises granules of tobacco material which are positioned in a receptacle in the form of a cup 24 that is positioned at the upstream end 6 of the smoking article 1. The combustible heat source 12 has a smaller diameter than an open end 26 of the cup 24 and, thus, extends into the open end 26 to retain the aerosol generating material 10 therein. The cup 24 includes a closed end 28 having air passages 30 which allow air to flow into the chamber 16.

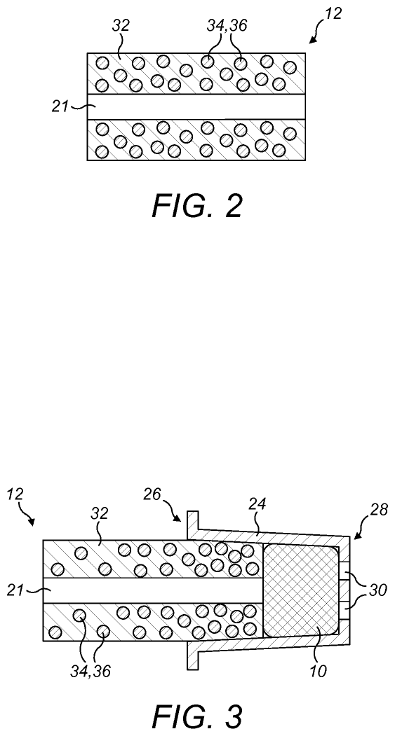

The combustible heat source 12 is typically a porous carbon-based heat source. The combustible heat source 12 is cylindrical and in the illustrated first embodiment comprises a central airflow passage 21 that extends longitudinally through the combustible heat source 12. The combustible heat source 12 comprises a carbon-based combustible material 32 and an inductively heatable susceptor 34 (FIGS. 2 to 6) for heating and thereby igniting the combustible material 32. The inductively heatable susceptor 34, and hence the combustible heat source 12, can take various forms as will now be described with reference to FIGS. 2 to 6.

A first example of a combustible heat source 12 is shown in FIG. 2. In this first example, the susceptor 34 comprises a plurality of particles of susceptor material 36 that are evenly distributed throughout the combustible material 32.

A second example of a combustible heat source 12 is shown in FIG. 3. In this second example, the susceptor 34 again comprises a plurality of particles of susceptor material 36 that are distributed throughout the combustible material 32. However, in contrast to the first example, the concentration of the particulate material 36 varies within the combustible material 32 in a longitudinal direction of the smoking article 1, thereby allowing the combustion process, and hence the heating of the aerosol generating material 10, to be controlled. In the illustrated example, it will be seen that the concentration of the particulate material 36 increases in the downstream direction and is at its highest immediately adjacent to the aerosol generating material 10. With this arrangement, the combustible material 32 at the downstream end of the combustible heat source 12 tends to be ignited before the combustible material 32 at the upstream end with the result that the aerosol generating material 10 is heated to a high temperature at an early point in time. In another example (not shown), the concentration of the particulate material 36 may decrease in the downstream direction and may be at its highest at the upstream end 6 of the article 1 in a region furthest away from the aerosol generating material 10. With this arrangement, the combustible material 32 at the upstream end tends to be ignited before the combustible material 32 at the downstream end with the result that the aerosol generating material 10 is heated to a high temperature at a later point in time.

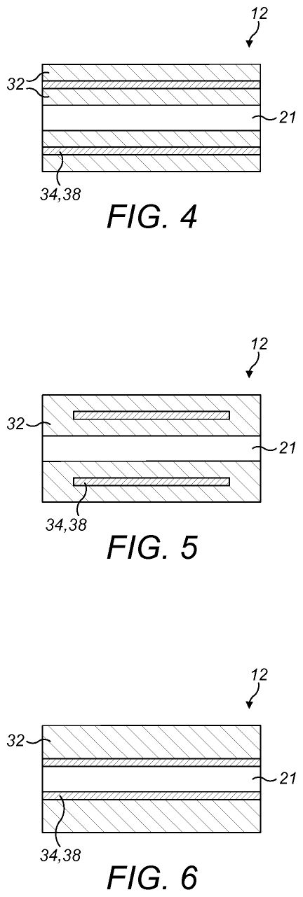

A third example of a combustible heat source 12 is shown in FIG. 4. In this third example, the inductively heatable susceptor 34 comprises a tubular susceptor 38 having a longitudinal axis which is substantially aligned with a longitudinal axis of the smoking article 1. The combustible material 32 is positioned in an interior of the tubular susceptor 38 and around an exterior of the tubular susceptor 38. The tubular susceptor 38 and the combustible heat source 12 also have the same axial length and are arranged so that their respective ends are axially aligned.

A fourth example of a combustible heat source 12 is shown in FIG. 5. The fourth example is similar to the third example described above with reference to FIG. 4, except that the axial length of the tubular susceptor 38 is less than the axial length of the combustible heat source 12 such that their respective ends are not axially aligned.

A fifth example of a combustible heat source 12 is shown in FIG. 6. In this fifth example, the inductively heatable susceptor 34 again comprises a tubular susceptor 38 having a longitudinal axis which is substantially aligned with a longitudinal axis of the smoking article 1. The interior of tubular susceptor 38 provides the airflow channel 21 and thus it will be seen that the combustible material 32 is positioned exclusively around an exterior of the tubular susceptor 38. With this arrangement, it will be understood that air flowing through the airflow passage 21 is isolated by the wall of the tubular susceptor 38 from the combustible material 32 positioned around its exterior.

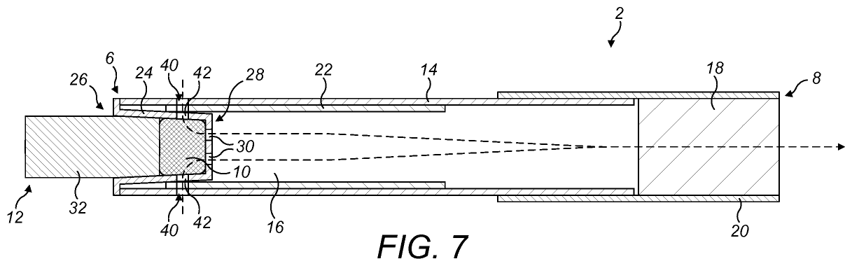

Referring now to FIG. 7, there is shown a second embodiment of a smoking article 2 which is similar to the smoking article 1 described above with reference to FIG. 1 and in which corresponding elements are designated using corresponding reference numerals.

In the smoking article 2, the combustible heat source 12 does not include an airflow passage and comprises a solid or continuous plug of porous combustible carbon-based material. The smoking article 2 includes air inlets 40 which allow air to flow through the cylindrical body 14 and the cylindrical liner 22. In addition, the cup 24 includes air passages 42 in its cylindrical surface to allow air from the air inlets 40 to flow through the aerosol generating material 10 before flowing through the air passages 30 and into the chamber 16 in the manner described above with reference to FIG. 1. The airflow through the smoking article 2, from the upstream end 6 to the downstream end 8, is again shown diagrammatically by the arrow in FIG. 7.

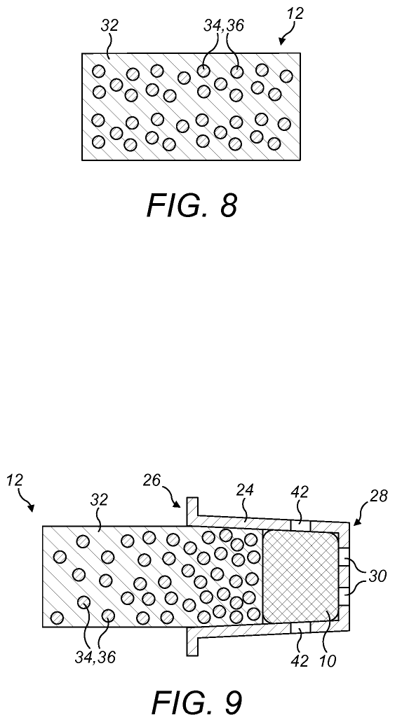

The inductively heatable susceptor 34, and hence the combustible heat source 12, for use with the smoking article 2 can take various forms as will now be described with reference to FIGS. 8 to 11.

A sixth example of a combustible heat source 12 is shown in FIG. 8. In this sixth example, the susceptor 34 comprises a plurality of particles of susceptor material 36 that are evenly distributed throughout the combustible material 32.

A seventh example of a combustible heat source 12 is shown in FIG. 9. In this seventh example, the susceptor 34 again comprises a plurality of particles of susceptor material 36 that are distributed throughout the combustible material 32. In this seventh example, the concentration of the particulate material 36 varies within the combustible material 32 in a longitudinal direction of the smoking article 2, thereby allowing the combustion process, and hence the heating of the aerosol generating material 10, to be controlled. In the illustrated example, it will be seen that the concentration of the particulate material 36 increases in the downstream direction and is at its highest immediately adjacent to the aerosol generating material 10. As explained above with reference to FIG. 3, with this arrangement the combustible material 32 at the downstream end of the combustible heat source 12 tends to be ignited before the combustible material 32 at the upstream end with the result that the aerosol generating material 10 is heated to a high temperature at an early point in time. Alternatively, the concentration of the particulate material 36 may decrease in the downstream direction and may be at its highest at the upstream end 6 of the article 2 in a region furthest away from the aerosol generating material 10. With this arrangement, the combustible material 32 at the upstream end tends to be ignited before the combustible material 32 at the downstream end with the result that the aerosol generating material 10 is heated to a high temperature at a later point in time.

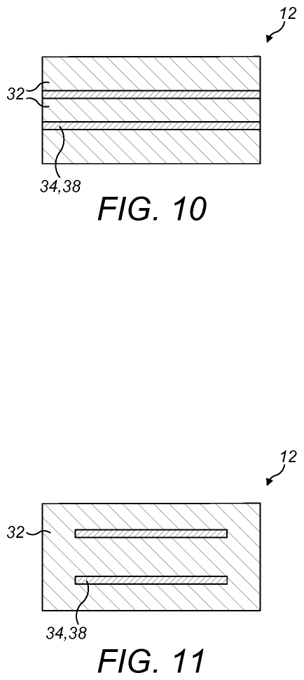

An eighth example of a combustible heat source 12 is shown in FIG. 10. In this eighth example, the inductively heatable susceptor 34 comprises a tubular susceptor 38 having a longitudinal axis which is substantially aligned with a longitudinal axis of the smoking article 2. The combustible material 32 is positioned in an interior of the tubular susceptor 38 and around an exterior of the tubular susceptor 38. The tubular susceptor 38 and the combustible heat source 12 also have the same axial length and are arranged so that their respective ends are axially aligned.

A ninth example of a combustible heat source 12 is shown in FIG. 11. The ninth example is similar to the eighth example described above with reference to FIG. 10, except that the axial length of the tubular susceptor 38 is less than the axial length of the combustible heat source 12 such that their respective ends are not axially aligned.

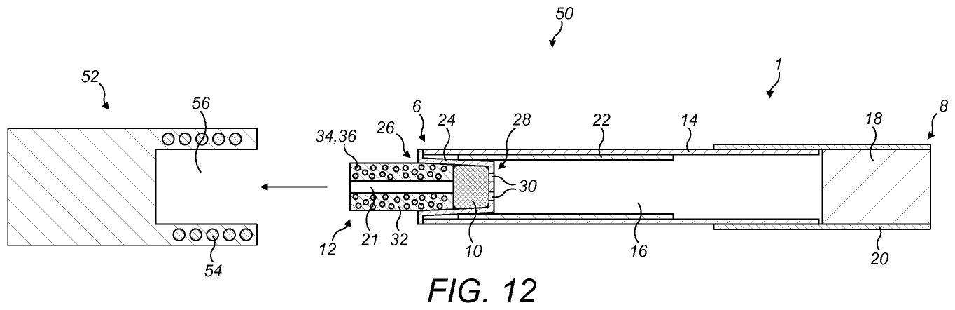

Referring now to FIGS. 12 to 15, there is shown a smoking system 50 for generating an aerosol for inhalation by a user. The smoking system 50 comprises the smoking article 1 illustrated in FIG. 1 in combination with the first example of the combustible heat source 12 illustrated in FIG. 2. It will, however, be understood that the smoking article 1 could be used in combination with any of the other examples of the combustible heat sources 12 illustrated in FIGS. 3 to 6 or that the smoking system 50 could alternatively comprise the smoking article 2 illustrated in FIG. 7 in combination with any of the examples of the combustible heat sources that are illustrated in FIGS. 8 to 11.

The smoking system 50 additionally comprises an igniter 52 for igniting the combustible material 32. The igniter 52 comprises a helical induction coil 54 which defines a cavity 56 for receiving the upstream end 6 of the smoking article 1.

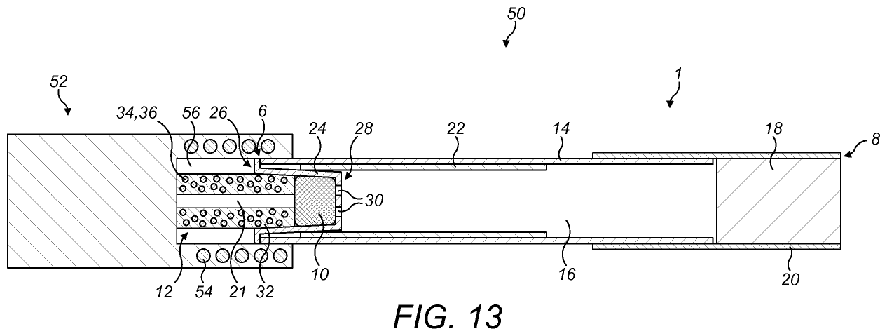

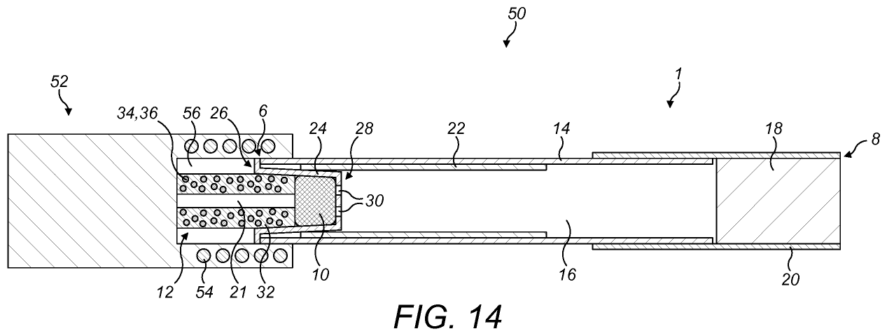

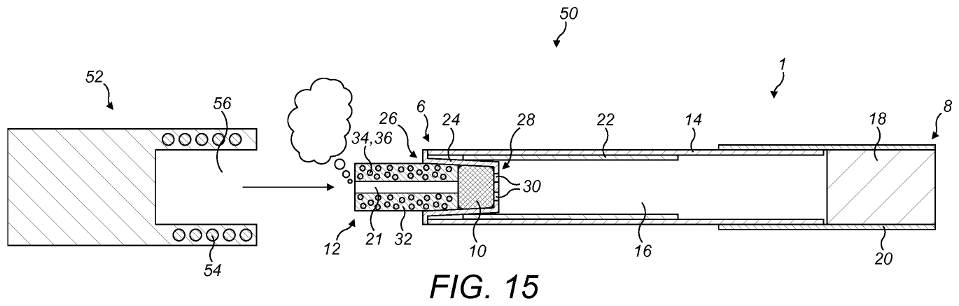

In use, a user positions the upstream end 6 of the smoking article 1 in the cavity 56 as shown in FIG. 13 and the igniter 52 is then activated, for example manually by the user or automatically by detecting the positioning of the smoking article 1 in the cavity 56. The igniter 56 comprises a controller and a power source (not shown). The controller includes, amongst other electronic components, an inverter which is arranged to convert a direct current from the power source into an alternating high-frequency current for the induction coil 54. As will be understood by one of ordinary skill in the art, when the induction coil 54 is energised by the alternating high-frequency current, an alternating and time-varying electromagnetic field is produced. This couples with the particulate susceptor material 36 and generates eddy currents and/or magnetic hysteresis losses in the particulate susceptor material 36 causing it to heat up as denoted diagrammatically by the modified cross-hatching in FIG. 14. The heat is then transferred from the particulate susceptor material 36 to the combustible material 32, for example by conduction, radiation and convection, causing the combustible material 32 to ignite and combust. After combustion has commenced, the upstream end of smoking article 1 is removed from the cavity 56 as shown in FIG. 15. The particulate susceptor material 36 is no longer heated by the time-varying electromagnetic field produced by the induction coil 54 following removal of the smoking article 1 from the cavity 56 but the combustible material 32 continues to combust.

In order to promote ignition and initial combustion of the combustible material 32, the igniter 52 can include an air supply mechanism (not shown), for example comprising a fan and an airflow passage at an upstream end of the cavity 56 to direct air to the combustible material 32 whilst it is being heated by the particulate susceptor material 36.

Heat from the ignited combustible material 32 is transferred to the aerosol generating material 10 and the aerosol generating material 10 is, thus, heated without being burned. Heating of the aerosol generating material 10 in this way volatises one or more components of the aerosol generating material 10. When a user engages their lips with the mouthpiece 18 and draws air through the smoking article 1, the air flows through the central airflow passage 21 where it is heated by heat transferred from the combustible material 32. The heated air then flows through the aerosol generating material 10 causing further heating of the aerosol generating material 10 and, hence, the further volatisation of one or more components of the aerosol generating material 10. The volatised components of the aerosol generating material 10 are entrained by the air flowing through the smoking article 1, and the heated air and entrained volatised components flow in the downstream direction into the chamber 16 where they cool and condense to form an aerosol which is inhaled by a user through the mouthpiece 18.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. A smoking article comprising:
aerosol generating material;
a combustible heat source for heating the aerosol generating material;
wherein the combustible heat source comprises a combustible material and an inductively heatable susceptor for heating and thereby igniting the combustible material.

2. The smoking article according to claim 1, wherein the inductively heatable susceptor comprises a plurality of particles of susceptor material distributed within the combustible material.

3. The smoking article according to claim 2, wherein the particles of susceptor material are distributed substantially evenly within the combustible material.

4. The smoking article according to claim 2, wherein the particles of susceptor material have a concentration which varies within the combustible material in a longitudinal direction of the article.

5. The smoking article according to claim 1, wherein the inductively heatable susceptor comprises a tubular member having a longitudinal axis which is substantially aligned with a longitudinal axis of the article.

6. The smoking article according to claim 5, wherein the combustible material is positioned in an interior of the tubular member and around an exterior of the tubular member.

7. The smoking article according to claim 5, wherein the combustible material is positioned exclusively around an exterior of the tubular member.

8. The smoking article according to claim 1, wherein no inductively heatable components other than the inductively heatable susceptor overlap the combustible material in a longitudinal direction of the article.

9. The smoking article according to claim 1, wherein the combustible material comprises a plurality of pores to allow ambient air to flow into the combustible material.

10. A smoking system comprising:
the smoking article according to claim 1;
an igniter for igniting the combustible material, the igniter comprising an induction coil For inductively heating the susceptor.

11. The smoking system according to claim 10, wherein the induction coil is helical and defines a cavity for receiving the smoking article.

12. The smoking system according to claim 11, wherein the induction coil surrounds substantially all of the susceptor when the smoking article is positioned in the cavity.

13. The smoking system according to claim 10, wherein the igniter comprises an air supply mechanism for supplying air to the combustible material.

14. A method for aerosol generation, the method comprising:
providing the smoking system according to claim 10;
positioning the combustible heat source proximate the induction coil so that the inductively heatable susceptor couples with, and is heated by, an electromagnetic field generated by the induction coil;
maintaining the position of the combustible heat source until the combustible material is ignited by the heated susceptor so that heat generated by the ignited combustible material heats the aerosol generating material to generate an aerosol.

15. The method for aerosol generation according to claim 14, wherein, after ignition of the combustible material by the heated susceptor, the method comprises removing the combustible heat source from its position proximate the induction coil to terminate heating of the inductively heatable susceptor by the electromagnetic field generated by the induction coil, and wherein the ignited combustible material continues to heat the aerosol generating material to generate the aerosol.
